(19) United States
(12) Patent Application Publication
(10) Pub. No.: US 2005/0225246 A1
(43) Pub. Date: Oct. 13, 2005

(54) Plasma display panel with reduced capacitance between address electrodes

(76) Inventors: Jeong-Nam Kim, Suwon-si (KR); Tae-Ho Lee, Suwon-si (KR); Yon-Goo Park, Suwon-si (KR); Min-Sun Yoo, Suwon-si (KR)

Correspondence Address: MCGUIREWOODS, LLP, 1750 TYSONS BLVD, SUITE 1800, MCLEAN, VA, 22102, US

(21) Appl. No.: 11/099,531

(22) Filed: Apr. 6, 2005

(30) Foreign Application Priority Data
Apr. 7, 2004 (KR) 10-2004-0023728

(51) Int. Cl. H01J 17/49

(52) U.S. Cl. 313/587; 313/586; 313/583

(57) ABSTRACT

A plasma display panel including a first substrate and a second substrate opposing one another with a predetermined gap therebetween, address electrodes formed along a first direction on the first substrate, and barrier ribs mounted in the gap between the first and second substrates and defining a plurality of discharge cells. First electrodes and second electrodes are formed on the second substrate along a second direction, which crosses the first direction. The address electrodes include expanded segments with an enlarged width in areas corresponding to the discharge cells, and indented segments that are indented at areas corresponding to gaps between the first electrodes and the second electrodes.

### CROSS REFERENCE TO RELATED APPLICATION

This application claims priority to and the benefit of Korean Patent Application No. 10-2004-0023728, filed on Apr. 7, 2004, which is hereby incorporated by reference for all purposes as if fully set forth herein.

### BACKGROUND OF THE INVENTION

1. Field of the Invention

The present invention relates to a plasma display panel (PDP), and more particularly, to a PDP having address electrodes that may consume less power during address discharge.

2. Description of the Background

A PDP displays images through plasma discharge. That is, applying a voltage between electrodes may generate a gas discharge that emits ultraviolet rays that excite phosphors, thereby displaying images. The PDP may offer many advantages over other display configurations including superior display capacity, brightness, and contrast, as well as a wide viewing angle. Consequently, the PDP is widely popular.

Depending on the arrangement of red (R), green (G), and blue (B) discharge cells, the PDP may be a stripe-type PDP, where the discharge cells are arranged in lines of the same color, or a delta-type PDP, where the discharge cells are grouped into a triangular configuration.

U.S. Pat. No. 5,182,489 (rectangular closed-type barrier ribs), Japanese Laid-Open Patent No. Heisei 6-44907 (hexagonal closed-type barrier ribs), and U.S. Pat. Nos. 6,373,195 and 6,376,986 (linear barrier ribs) disclose delta-type PDPs. U.S. Pat. No. 5,841,232 discloses a stripe-type PDP.

PDPs may be similarly driven, regardless of the type of barrier rib structure utilized. Namely, in stripe-type and delta-type PDPs, address electrodes may be formed on a rear substrate at locations corresponding to each discharge cell, and scan electrodes and sustain electrodes may be formed on a front substrate. Applying an address voltage between the address electrodes and the scan electrodes addresses corresponding discharge cells, and then applying a sustain voltage between the sustain electrodes and the scan electrodes displays images.

Generally, increased capacitance is a common drawback of PDPs. In particular, increasing the PDP's resolution requires more discharge cells. However, more discharge cells reduces a gap between address electrodes, which increases capacitance due to the effect of the gap on power consumption during address discharge. That is, the address electrode gap is inversely proportional to capacitance. An increase in capacitance adversely affects the PDP's operational characteristics. This may be particularly so with the delta-type PDP.

Further, a method of scanning the scan electrodes during the address period may change from a dual scan method (simultaneous scanning of upper and lower regions of the screen) to a single scan method (scanning starting from either the upper or lower region of the screen), which doubles the length of the address electrodes. Consequently, capacitance between address electrodes increases, as does frequency, thereby increasing power consumption. That is, capacitance is proportional to address electrode length, and power consumption is proportional to capacitance and frequency. Hence, increases in address electrode length and frequency may result in greater power consumption.

### SUMMARY OF THE INVENTION

The present invention provides a PDP having reduced capacitance between address electrodes, thereby minimizing power consumption.

Additional features of the invention will be set forth in the description which follows, and in part will be apparent from the description, or may be learned by practice of the invention.

The present invention discloses a PDP comprising a first substrate and a second substrate opposing one another with a first gap therebetween, an address electrode formed on the first substrate along a first direction, barrier ribs in the first gap and defining a plurality of discharge cells, and a first electrode and a second electrode formed on the second substrate along a second direction, which is substantially perpendicular to the first direction. The address electrode includes an expanded segment in an area corresponding to a discharge cell and an indented segment in an area corresponding to a second gap between the first electrode and the second electrode.

The present invention also discloses a display panel comprising a first substrate and a second substrate opposing one another, an address electrode formed on the first substrate and along a first direction, a plurality of discharge cells, and display electrodes formed on the second substrate and along a second direction. The address electrode includes an expanded segment in an area corresponding to a discharge cell, and the expanded segment includes an indented segment. A portion of the indented segment is not overlapped by the display electrodes.

The present invention also discloses a PDP comprising a first substrate, an address electrode formed on the first substrate, a dielectric layer covering the address electrode, and barrier ribs formed on the dielectric layer and defining a plurality of discharge cells. The address electrode is formed in a first area corresponding to a discharge cell and in a second area under a barrier rib, and a permittivity of the dielectric layer in the first area differs from a permittivity of the dielectric layer in the second area.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a partial exploded perspective view showing a PDP according to an exemplary embodiment of the present invention.

FIG. 2 is a partial sectional view showing the PDP of FIG. 1 as assembled.

FIG. 3 is a schematic plan view showing a pixel arrangement of the PDP of FIG. 1.

FIG. 4A is a partial plan view showing the PDP of FIG. 1.

FIG. 4B is a partial plan view showing the PDP of FIG. 1.

FIG. 5 is a partial plan view showing a unit discharge cell of a PDP according to another exemplary embodiment of the present invention.

FIG. 6 is a partial plan view showing a PDP according to yet another exemplary embodiment of the present invention.

### DETAILED DESCRIPTION OF THE ILLUSTRATED EMBODIMENTS

Exemplary embodiments of the present invention will now be described with reference to the drawings.

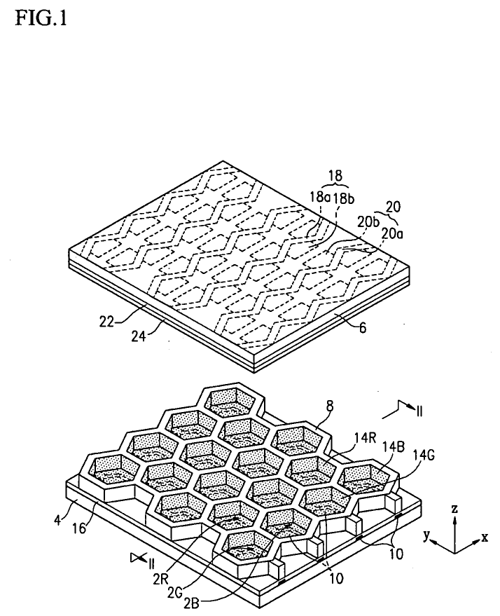

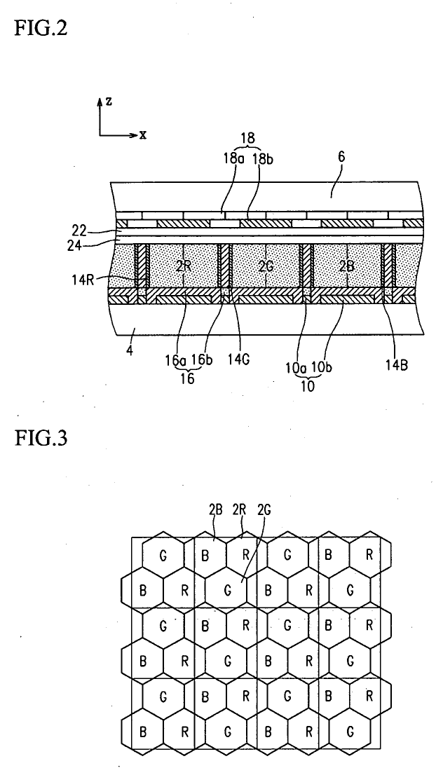

FIG. 1 is a partial exploded perspective view showing a PDP according to an exemplary embodiment of the present invention, FIG. 2 is a partial sectional view showing the PDP of FIG. 1, as assembled, and FIG. 3 is a schematic plan view showing a pixel arrangement of the PDP of FIG. 1.

Referring to FIG. 1, FIG. 2 and FIG. 3, discharge cells 2R, 2G, 2B may be arranged in a delta configuration. That is, three discharge cells comprising a red discharge cell 2R, a green discharge cell 2G, and a blue discharge cell 2B are provided in a triangular configuration to form a pixel.

The PDP may include a first substrate 4 and a second substrate 6 provided substantially parallel to one another with a predetermined gap therebetween. Barrier ribs 8 may be formed in a predetermined pattern between the first substrate 4 and the second substrate 6 to thereby define the pixels, where each pixel comprises three subpixels, (i.e. three discharge cells 2R, 2G, 2B). In the exemplary embodiment, the barrier ribs 8 define discharge cells 2R, 2G, 2B having a hexagonal planar shape.

A discharge gas may be filled in the hexagonal spaces defined by the discharge cells 2R, 2G, 2B. Further, red, green, and blue phosphor layers 14R, 14G, 14B may be formed in the discharge cells 2R, 2G, 2B, respectively. The phosphor layers 14R, 14G, 14B may be deposited on a bottom surface of the discharge cells 2R, 2G, 2B, as well as on side walls of the barrier ribs 8.

Address electrodes 10 may be formed on a surface of the first substrate 4 opposing the second substrate 6 and along a first direction (i.e., direction y in the drawings). A first dielectric layer 16 may cover the address electrodes 10.

In the exemplary embodiment, the first dielectric layer 16 includes first dielectric regions 16a and second dielectric regions 16b, which have different permittivities. The first dielectric regions 16a may be formed at areas corresponding to the discharge cells 2R, 2G, 2B, while the second dielectric regions 16b may be formed under the barrier ribs 8 where discharge does not take place.

As noted above, power consumption is proportional to a capacitance between the address electrodes 10, and this capacitance, in turn, is proportional to permittivity. Hence, in order to reduce the PDP's power consumption, the permittivity of the second dielectric regions 16b may be less than the permittivity of the first dielectric regions 16a, which reduces the capacitance between the address electrodes 10. Further, the first dielectric regions 16a and the second dielectric regions 16b respectively may have the same width as the address electrodes.

Alternatively, the dielectric layer 16 may be formed having varying thicknesses, which varies its capacitance. In this case, the first dielectric regions 16a may be thinner than the second dielectric regions 16b.

Although the first and second dielectric regions 16a, 16b are shown as one layer in FIG. 2, a multi-layered structure may provide the dielectric layer 16 with different permittivities, i.e., different capacitances.

The dielectric layer 16 may be made using PbO, SiO₂, B₂O₃, Al₂O₃, TiO₂, and other such compounds as its base material. Since PbO and SiO₂ may determine the dielectric layer's permittivity, suitably adjusting their amounts in different areas of the layer varies the layer's permittivity. That is, since PbO has a high permittivity, and SiO₂ has a low permittivity, the first dielectric regions 16a may contain less PbO or more SiO₂ than the second dielectric regions 16b.

The address electrodes 10 may be formed corresponding to the shape of the discharge cells 2R, 2G, 2B, and predetermined gaps are provided between adjacent address electrodes.

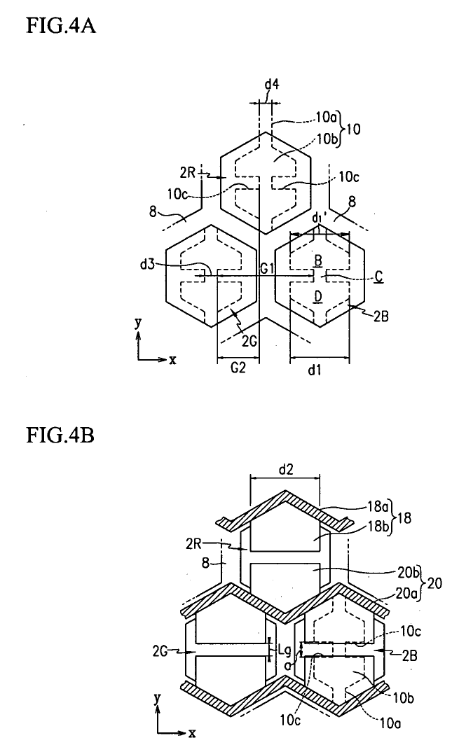

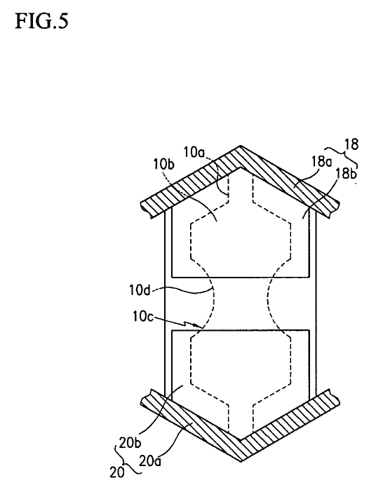

Referring to FIG. 4A and FIG. 4B, the address electrodes 10 may include line segments 10a, which may be formed along direction y and under the barrier ribs 8, and expanded segments 10b, which may be positioned at areas corresponding to the discharge cells 2R, 2G, 2B. A width d_{1′} or d₁ of the expanded segments 10b along a second direction (i.e., direction x in the drawings) may be greater than a width d₄ of the line segments 10a. The expanded segments 10b may be formed substantially in a hexagonal shape corresponding to the shape of the discharge cells 2R, 2G, 2B. The shape of the address electrodes 10 will be described in more detail below.

Referring to FIG. 1, FIG. 2, and FIG. 4B, first electrodes 18 (X electrodes) and second electrodes 20 (Y electrodes) may be formed on a surface of the second substrate 6 opposing the first substrate 4. The X electrodes 18 and the Y electrodes 20 may be formed along direction x. Further, the X and Y electrodes 18, 20 may include bus electrodes 18a, 20a and protruding electrodes 18b, 20b, respectively. The bus electrodes 18a, 20a may be formed corresponding to the shape of the barrier ribs 8 along direction x, and the protruding electrodes 18b, 20b protrude from the bus electrodes 18a, 20a along direction y toward centers of the discharge cells 2R, 2G, 2B, such that a protruding electrode 18b and a protruding electrode 20b oppose one another in areas corresponding to each discharge cell 2R, 2G, 2B.

The bus electrodes 18a, 20a may be made of a non-transparent material such as metal, and they may be mounted over, and corresponding to, the shape of the barrier ribs 8 along direction x. Hence, the bus electrodes 18a, 20a may have a zigzag shape. The bus electrodes 18a, 20a may also be formed as narrow as possible so they do not block visible light emitted from the discharge cells 2R, 2G, 2B. The protruding electrodes 18b, 20b may be made of a transparent material such as indium tin oxide (ITO).

A second dielectric layer 22 may cover the X electrodes 18 and the Y electrodes 20, and a protection layer 24, which may be made of MgO or other like materials, may cover the second dielectric layer 22.

In the exemplary embodiment, the configuration of the expanded segments 10b of the address electrodes 10 increases gaps between address electrodes 10, ultimately decreasing the PDP's power consumption. Formula 1, which provides capacitance, shows that if the electrode gap increases, capacitance, which is inversely proportional to electrode gap, decreases. Power consumption may also decrease due to the linear relation between power consumption and capacitance.

$$C = ɛ \frac{A}{d} \qquad [ Formula 1 ]$$

where C is the capacitance between the address electrodes, d is the gap between the address electrodes 10, A is the area between the address electrodes, and ε is the permittivity between the electrodes.

Referring again to FIG. 4A and FIG. 4B, the address electrodes 10 may include the expanded segments 10b with an overall hexagonal shape corresponding to the shape of the discharge cells 2R, 2G, 2B as described above. The expanded segments 10b may also be formed in the gap between the X electrodes 18 and the Y electrodes 20. Further, the expanded segments 10b may have a pair of indented segments 10c formed by removing opposite portions of the expanded segments 10b at areas corresponding to the centers of the discharge cells 2R, 2G, 2B, thereby reducing a width of the expanded segments 10b at these areas. Since the area of the address electrodes 10 affects a drive margin of an address voltage, gaps G1, G2 between the address electrodes 10 may be increased while limiting variations in their shape. Accordingly, the indented segments 10c may be formed where the address electrodes 10 do not overlap with the X electrodes 18 and the Y electrodes 20. In the exemplary embodiment, the indented segments 10c are formed between the protruded electrodes 18b, 20b of the X and Y electrodes 18, 20 (second region C in FIG. 4A). The indented segments 10c may be formed such that their width (a in FIG. 4B) along direction y is equal to or greater than a distance Lg between opposing pairs of the protruding electrodes 18b, 20b.

The indented segments 10c shown in FIG. 4A and FIG. 4B are rectangular cutout sections of the expanded segments 10b. However, as FIG. 5 shows, the indented segments 10c may have a rounded shape, thereby forming arcs 10d. In this case, centers of the arcs 10d may be closer to the X electrodes 18 than the Y electrodes 20.

As FIGS. 4A and 4B show, the expanded segments 10b may be divided into a first region B, which is adjacent to the X electrodes 18, the second region C, which is between the X electrodes 18 and the Y electrodes 20, and a third region D, which is adjacent to the Y electrodes 20. Taken along direction x, a width d₁ of the first region B and a width d₁ of the third region D may be less than a width d₂ of the protruding electrodes 18b, 20b. Further, a width d₃ of the 20 second region C may be 20 μm or greater.

Further, the width d_{1′} of the protruding electrodes 18b may be equal to or less than the width d, of the protruding electrodes 20b. This increases the discharge regions D between the Y electrodes 20 and the address electrodes 10, thereby enabling easier address discharge while reducing mis-discharge (i.e., a discharge between an X electrode and an address electrode) in the address period.

Forming the indented segments 10c significantly increases the gap G1 between address electrodes 10 of adjacent discharge cells. Further, the indented segments 10c also increase the gap G2 between address electrodes 10 of diagonally adjacent discharge cells. The increased gaps G1, G2 reduce address electrode capacitance.

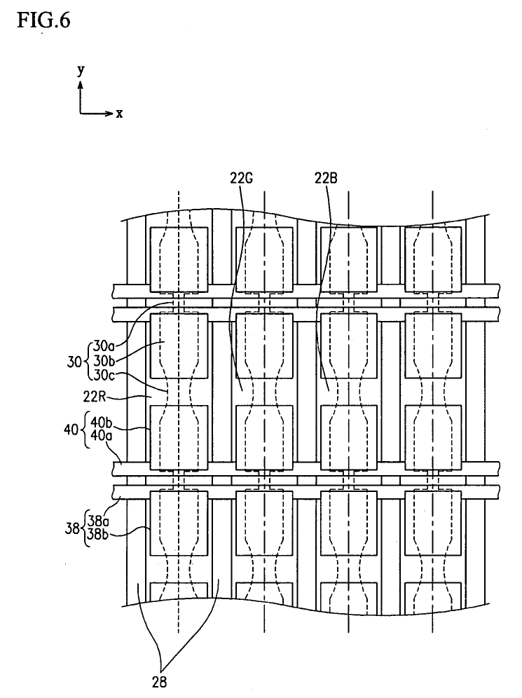

FIG. 6 shows an exemplary embodiment of the present invention applied to a stripe-type PDP. Discharge cells 22R, 22G, 22B may be defined by barrier ribs 28, which are formed in a lattice pattern by intersecting horizontal barrier ribs and vertical barrier ribs.

Address electrodes 30 may include expanded segments 30b at areas corresponding to the discharge cells 22R, 22G, 22B. In this exemplary embodiment, since the discharge cells 22R, 22G, 22B are substantially rectangular, the expanded segments 30b may also have a substantially rectangular shape.

Further, centers of the expanded segments 30b may be indented along direction x to form indented segments 30c. The shape of the indented segments 30c preferably is determined based on the conditions of the above embodiments. Also, the indented segments 30c may be rounded as shown, or they may be angled. The X and Y electrodes 38 and 40, as well as their bus electrodes 38a, 40a and protruded electrodes 38b, 40b, respectively, may be formed with similar conditions as the X and Y electrodes 18 and 20.

While exemplary embodiments of the present invention are shown and described in relation to a PDP, the address electrodes of the present invention are not limited thereto. They may be formed in a display panel having opposing substrates with address electrodes on one substrate and display electrodes on another.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

1. A plasma display panel, comprising:
a first substrate and a second substrate opposing one another with a first gap therebetween;
an address electrode formed on the first substrate along a first direction;
barrier ribs in the first gap and defining a plurality of discharge cells; and
a first electrode and a second electrode formed on the second substrate along a second direction intersecting the first direction,
wherein the address electrode includes an expanded segment in an area corresponding to a discharge cell and an indented segment in an area corresponding to a second gap between the first electrode and the second electrode.

2. The plasma display panel of claim 1, wherein a third gap between adjacent address electrodes is at a maximum between indented segments.

3. The plasma display panel of claim 1, wherein the indented segment is formed in an area substantially corresponding to a center of the discharge cell.

4. The plasma display panel of claim 1,
wherein the expanded segment includes a first portion opposing the first electrode and a second portion opposing the second electrode,
wherein a scan voltage is applied to the second electrode in an address period, and
wherein the second portion is at least as wide as the first portion.

5. The plasma display panel of claim 1,
wherein the first electrode and the second electrode respectively include a bus electrode formed along the second direction and a protruding electrode protruded from the bus electrode toward a center of the discharge cell, and
wherein the second gap is formed by the protruding electrode of the first electrode and the protruding electrode of the second electrode.

6. The plasma display panel of claim 5, wherein the expanded segment is not wider than the protruding electrode of the first electrode and the protruding electrode of the second electrode.

7. The plasma display panel of claim 1, wherein the indented segment is rounded.

8. The plasma display panel of claim 7,
wherein the indented segment is formed as an arc,
wherein a center of the arc is closer to the first electrode, and
wherein a scan voltage is applied to the second electrode during an address period.

9. The plasma display panel of claim 1, wherein the indented segment is angled.

10. The plasma display panel of claim 1, wherein the discharge cells are arranged in a delta configuration comprising one discharge cell having a red phosphor layer, one discharge cell having a green phosphor layer, and one discharge cell having a blue phosphor layer forming a pixel.

11. The plasma display panel of claim 10, further comprising:
a dielectric layer covering the address electrode,
wherein the dielectric layer has areas formed with differing permittivities.

12. The plasma display panel of claim 11,
wherein the address electrode further includes a line segment coupling expanded segments,
wherein the dielectric layer includes a first dielectric region covering the expanded segment and a second dielectric region covering the line segment, and
wherein a permittivity of the first dielectric region is less than a permittivity of the second dielectric region.

13. The plasma display panel of claim 12,
wherein the first dielectric region and the expanded segment are equally wide, and
wherein the second dielectric region and the line segment are equally wide.

14. The plasma display panel of claim 10, wherein the indented segment is positioned substantially at a center of the discharge cell.

15. The plasma display panel of claim 10,
wherein the expanded segment includes a first portion opposing the first electrode and a second portion opposing the second electrode,
wherein a scan voltage is applied to the second electrode in an address period, and
wherein the second portion is at least as wide as the first portion.

16. The plasma display panel of claim 10,
wherein the first electrode and the second electrode respectively include a bus electrode formed along the second direction and a protruding electrode protruded from the bus electrode toward a center of the discharge cell, and
wherein the second gap is formed by the protruding electrode of the first electrode and the protruding electrode of the second electrode.

17. The plasma display panel of claim 16, wherein the expanded segment is not wider than the protruding electrode of the first electrode and the protruding electrode of the second electrode.

18. A display panel, comprising:
a first substrate and a second substrate opposing one another;
an address electrode formed on the first substrate and along a first direction;
a plurality of discharge cells; and
display electrodes formed on the second substrate and along a second direction;
wherein the address electrode includes an expanded segment in an area corresponding to a discharge cell,
wherein the expanded segment includes an indented segment,
wherein a portion of the indented segment is not overlapped by the display electrodes.

19. A plasma display panel, comprising:
a first substrate;
an address electrode formed on the first substrate;
a dielectric layer covering the address electrode; and
barrier ribs formed on the dielectric layer and defining a plurality of discharge cells,
wherein the address electrode is formed in a first area corresponding to a discharge cell and in a second area under a barrier rib,
wherein a permittivity of the dielectric layer in the first area differs from a permittivity of the dielectric layer in the second area.

20. The plasma display panel of claim 19,
wherein the address electrode includes an expanded segment in the first area and a line segment in the second area, and
wherein the permittivity of the dielectric layer in the first area is less than the permittivity of the dielectric layer the second area.
